(19) United States
(12) Patent Application Publication
(10) Pub. No.: US 2024/0033548 A1
(43) Pub. Date: Feb. 1, 2024

(54) FIRE PREVENTION SYSTEM

(71) Applicant: ELECTROLUX HOME PRODUCTS INC., Charlotte, TN (US)

(72) Inventors: John W. TAYLOR, Charlotte, NC (US); Sabari GOPALAKRISHNAN, Springfield, TN (US); Christopher James Mills, Springfield, TN (US); David Gadd, Springfield, TN (US)

(21) Appl. No.: 18/028,817

(22) PCT Filed: Dec. 18, 2020
(86) PCT No.: PCT/US2020/065852

§ 371 Date: Mar. 28, 2023

Related U.S. Application Data
(60) Provisional application No. 63/087,980, filed on Oct. 6, 2020.

(51) Int. Cl. A62C 3/00; F24C 7/08

(52) U.S. Cl. CPC A62C 3/006; F24C 7/08

(57) ABSTRACT

A fire prevention system for a cooking appliance is described. The system includes a contactless temperature sensor for surveying the appliance and determining if a temperature emanating from the appliance is equal to or greater than 285 degrees Celsius. A time of flight sensor is also included to determine the presence or absence of a utensil on the appliance, if a utensil is present, fire prevention measures are undertaken; while if a utensil is absent, hot surface warnings are initiated.

### BACKGROUND OF THE INVENTION

The present disclosure relates to fire prevention systems and more particularly to a fire prevention system and method for appliances such as cooktops with heat generating surfaces upon which utensils accommodating foodstuff for cooking are placed. Current systems addressing fires suffer from a number of disadvantages negatively affecting the systems' effectiveness. For example, many of the current systems are reactive rather than proactive, namely, they only introduce fire suppression measures, if at all, after a fire has been detected, rather than proactively address conditions leading up to the fire itself and acting in advance to mediate the situation. Still further, where attention is paid to fire prevention, such attention is restricted to considerations of current temperature rather than additional considerations such duration and/or intensity of a detected high temperature and the like. Absent such considerations, prevention efforts, arguably fire suppression efforts, become limited at best and ineffective at worse as well as may lead to false positives as may occur during temperature spikes arising from a temporary flaming of a foodstuff preparation and the like. Limited systems addressing fire do not provide the user with a level of comfort and confidence to not be distracted from cooking duties that an otherwise proactive fire prevention system may provide. With current systems retroactively remediating flammable conditions, such as a kitchen fire, the user is relegated to damage control rather than damage prevention. Additionally, current fire suppression measures, with their post fire warning, make dangerous and difficult, if not impossible, for a user to turn off or otherwise disengage the heat generation of the appliance as well as introduce other fire suppression and/or remediation efforts. Accordingly, there is a need for a robust solution extending across different cooking appliances and heat generation methods, such methods including but not limited to induction, radiance and gas. Likewise, the need extends to different cooking appliances, including cooktop, free standing ranges with cooktop on top, hood, microwave ovens and the like.

Current fire prevention systems are further bulky and oftentimes reside in or near the field of view or operation of the user thereby obstructing or at least hindering use of the appliance. Furthermore, such bulky systems often require complex, intrusive and expensive installations and maintenance, thereby adding to their undesirability.

Current fire addressing systems further do not take into account the presence or absence of utensils on heating elements when assessing whether a fire has or will eminently break out. While current systems may consider utensils and their contents per se when assessing fire potential situations, such systems rely on detecting of heat passing particular thresholds. Such binary considerations do not first assess whether, for example, a utensil is present thus adjust its determinations, assessments and reactions accordingly. Further, the trigger for warnings of such systems is the actual or eminent outbreak of the fire itself, thus relegating these systems to fire suppression rather than fire prevention systems.

A number of solutions have been proposed in the art to affect the aforementioned. For example, Bach, in U.S. Pat. No. 9,109,805, proposes a range hood 115 including a number of temperature sensors 120, arranged in the range hood and positioned in either a one to one relationship to heating elements 105 on a cooktop surface 110 (see FIG. 1) or one to all single sensor 140 for an entirety of the cooktop surface (see FIG. 2). The temperature sensor may be used to detect the temperature of a heating element and/or of the cooktop surface in its entirety and/or that which is cooking on the heating element. Illumination warning devices 125 may be arranged to illuminate warning messages on particular dangerously hot heating elements (see FIG. 3) or generally on and for the surface itself (see FIG. 4). Regarding the potential for fire, Bach's only mention of the same is with respect to engaging smoke detectors for determining likely flammable conditions or their already occurrence (see paragraph 0039). In response thereto, Bach proposes remedial measures such as alarms and fire suppression systems activations. As with current systems, Bach's engagement with fire occurs late in the detection process, namely, after sufficient smoke is present to indicate a fire, thereby resulting in suppression rather than prevention efforts to be considered and undertaken.

Kamei, in U.S. patent application Ser. No. 15/477,192, is directed to a cooking support system 100 that monitors cooking surface temperatures with the aid of: control device 110, processing unit 190, light emitter 191, camera 192 and overhead infrared sensor 193; all of which are positioned overhead from the cooktop 300. In operation, Kamei uses camera 192 to capture an image of a cooking surface including any cookware 400 that may be positioned thereon. The IR sensor is then used to detect a temperature of each cooking surface including any cookware atop the cooking surface. The temperature and location of temperature are fed to the processing unit which, in turn, is then used to recognize when portions of the cookware may be overheating. Upon detection of a dangerous condition, a warning to the cooktop operator is triggered via the light emitter emitting a particular warning light onto the cooktop. Here, Kamei particularly measures portions of cookware edges and compares such measured temperatures with predetermined thresholds, the exceeding of which becomes indicative of the warning situation. Kamei does not take fire prevention per se into consideration.

Johnson, in U.S. patent application Ser. No. 14/924,900, is directed to a cooktop appliance 12 including a cooking surface 14 with heating elements 16 arranged to heat up cooking utensils 18. A cookware temperature sensor 28 and food sensor 30 associated with the cookware are further included whereby the food sensor is a probe which is physically positioned within the utensil 18 to physically engage foodstuff therein. Accordingly, the sensor determines the temperature of the food. As with the aforementioned references, Johnson focuses on dangerous situations which, as may be the case here, may result in burnt food. Accordingly, measurements of both the different temperatures of the food and the utensil are taken and compared with a threshold. Exceeding the threshold is understood to be a warning situation necessitating prevention measures such as reducing the heat being generated under the utensil. Johnson does not perform temperature sensing in an overhead and contactless manner; nor does Johnson take does not take fire prevention per se into consideration.

### BRIEF SUMMARY OF THE INVENTION

Accordingly, embodiments of the present disclosure are provided to substantially obviate one or more of the problems arising out of the limitations and disadvantages of the related art in providing fire prevention systems and solutions for appliances used in the preparation of foodstuff, including providing a remote and contactless sensor such that the appliance is within the sensor's field of view, the temperature sensor being configured to survey the appliance temperature landscape; a time of flight sensor with the appliance also in the sensor's field of view, the time of flight sensor configured to determine the presence or absence of a utensil on the appliance; and a processor appropriately arranged and configured to determine if a detected temperature surpasses a threshold based in part on the utensil's presence or absence and initiate prevention measures of the threshold is exceeded.

Further embodiments of the present disclosure are directed to detecting a rate of change of temperature and comparing the same with another threshold based at least in part on the utensil's presence or absence and triggering prevention measures when the another threshold is or is about to be exceeded. Still further embodiments of the present disclosure take into consideration a type of utensil, type of foodstuff and/or recipe being prepared, kitchen environmental conditions and the like.

A temperature threshold for any of the above may be equal to or greater than 285 degrees Celsius and a rate of change may be that envisioned by the skilled person. At least one of the temperature sensor and time of flight sensor may operate in the infrared. The prevention measures may include at least one of audio and visual alarms along with safety turn off instructions. The audio alarms may be human audible and generated locally and/or remotely. The visual alarms may include alpha-numeric characters, colors, images and the like displayed directly on the appliance, utensil, foodstuff, nearby surface and the like. The instructions may be communicated wired or wirelessly to the appliance for automatic heat generation reduction and/or shutoff. The prevention measures may further include hazardous condition suppression or prevention introduction of material(s).

The system according to embodiments of the present disclosure may be mounted in a vent hood or in a swing arm such that the appliance may fall within the field of view of the sensors. Additional mounting may be made with respect to monitoring operation of a microwave oven. The aforementioned mountings may be affected through magnetic elements and/or other such means. The system may be mounted above the appliance whose heat generating capabilities may include induction, radiance, gas and the like; and the appliance may include cooktop, free standing range with cooktop on top, hood, microwave and the like. Accordingly, the system is robust and enjoys wide application. Appliance and cooktop are used interchangeably throughout. Utensils are depicted as common household utensils for illustrative purposes. Likewise, for illustration purposes, application of embodiments of the present disclosure will be with respect to a cooktop surface upon which utensils may be placed in order to heat contents of the utensils by virtue of heat transfer from a cooktop surface heating element to the utensils' containing portion. The presently disclosed embodiments are not limited by any particular appliance, its configuration nor its heat generation capabilities.

### BRIEF DESCRIPTION OF THE SEVERAL VIEWS OF THE DRAWINGS

The accompanying drawings, which are incorporated in and constitute a part of this disclosure, illustrate exemplary embodiments and, together with the description, serve to explain the disclosed principals.

FIGS. 1A and 1B depict an application of the fire prevention system according to embodiments of the present disclosure.

FIG. 1C depicts an operation of a temperature sensor.

FIG. 1D depicts an application of a temperature sensor across a cooktop surface, including a surveying of cooktop surface temperature.

FIG. 1E depicts an application of a temperature sensor on a cooktop heating element, including a pivoting of the temperature sensor.

FIG. 1F depicts components of a temperature sensor as may be applied in a current application.

FIG. 1G depicts application of a time of a flight sensor to liquid level detection and utensil presence determination.

FIG. 1H depicts an operation of a digital light processor.

FIGS. 2A-2B depict a fire prevention system mounted in a vent hood from different angles and considerations.

FIG. 2C depicts a fire prevention system mounted in a swing arm.

FIG. 2D depicts a combination of different measurement spots from the present fire prevention system.

FIG. 3A-3B depict an exploded view and an assembled view of the fire prevention system.

FIG. 4A-4B depict applications of the present fire prevention system.

FIG. 5 depicts a method for applying the present fire prevention system according to embodiments of the present disclosure.

### DETAILED DESCRIPTION OF THE INVENTION

The technology described herein finds application in preventing fires and additional application in supporting safe use of a cooktop and automatic introduction of remediation measures. Typically, a utensil used in food preparation is brought proximate to a heat source so that heat is transferred from heat source to utensil. Foodstuff, any substance that is used as food or to make a meal, may be accommodated with or within the utensil with the transferred heat facilitating the utensil operation on the foodstuff, namely, foodstuff may be placed in a utensil on a heating source and cooked for a particular amount of time and temperature such that the foodstuff attains certain, preferably desired, states. At times, desired states for foodstuff preparation may not be necessarily achieved in a time and manner originally envisioned and further still may give rise to dangerous or hazardous conditions including hot to the touch surfaces and eminently flammable or ignitable conditions. Accordingly, chefs and others operating the appliance or located nearby, would benefit from any additional support with foodstuff preparation and more particularly for the timely, effective and readily understandable identification of the aforementioned and related hazardous situations and/or conditions. Additional benefit may be derived from automatic implementation of prevention measures including but not limited to effective communications of warnings as related to particular hazardous situations and/or conditions; automatic remediation steps, including safety switch-offs; and the like. The effective communications may be audio, visual, electronic and any combination of the aforementioned.

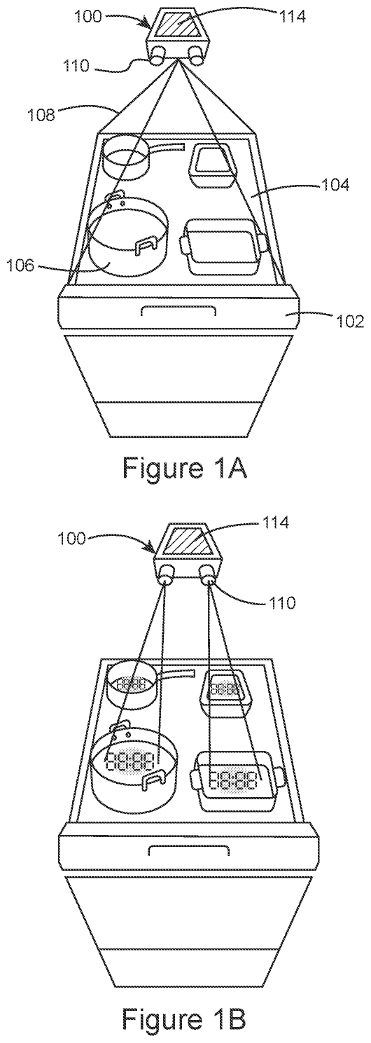

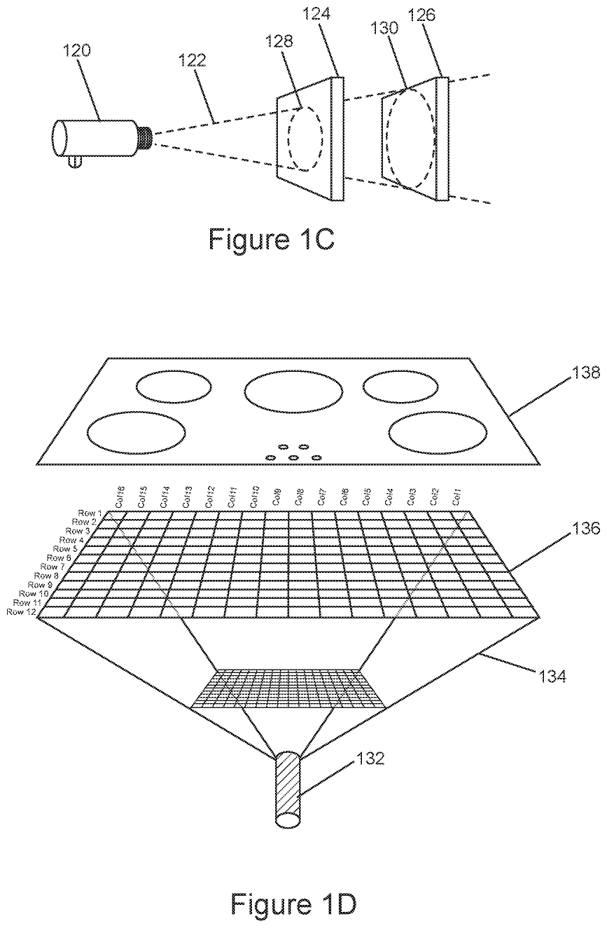

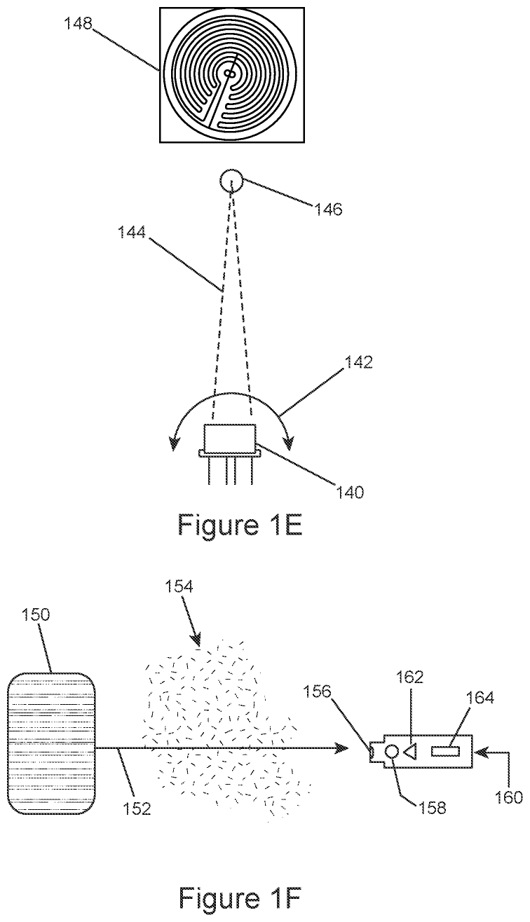

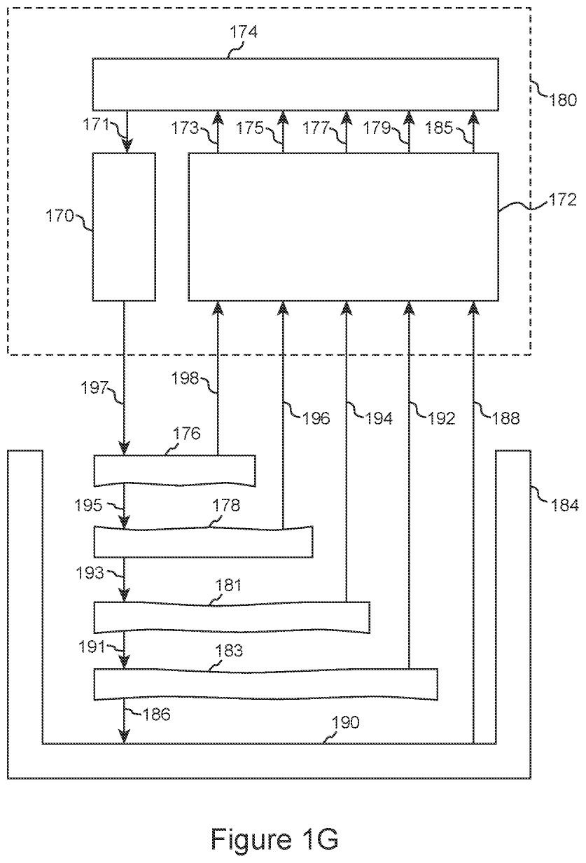

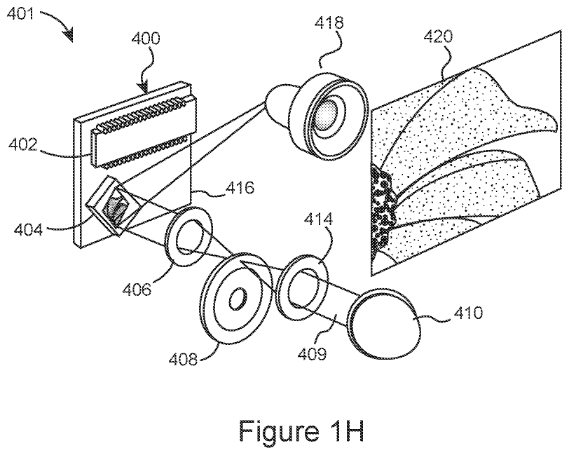

FIG. 1A depicts an environment in which a first embodiment of the fire prevention system 100 may operate. As shown, the fire prevention system 100 is arranged above a cooktop 102 having a cooktop surface 104 with a number of heating elements (not shown) upon which a number of utensils 106 rest. Accordingly, the cooktop surface is within the fire prevention system's field of view 108. As may be envisioned, the fire prevention system 100 may be arranged in any suitable location enabling and/or facilitating the aforementioned.

The fire prevention system 100 comprises at least one temperature sensor, at least one time of flight (ToF) sensor and at least one digital light processor (DLP) assembly 110. The temperature sensor and ToF sensor may be a remote and contactless sensors operating in the infrared. The DLP may operate by laser.

At least one processor is included in the fire prevention system 100, the processor being optionally arranged on a single board computer. Examples of known single board computers include the Beagleboard series available from Texas Instruments and Raspberry PI series available from the Raspberry PI Foundation. The processor may be arranged in communication with the cooktop and its controls in particular such that heat generation information, such as inputted or current temperature settings are communicated with the processor for subsequent consideration thereby including comparison with certain thresholds indicative of the aforementioned and other hazardous conditions. The comparison may be undertaken regularly by way of a feedback loop as will be described hereinbelow.

The temperature sensor is arranged in electrical communication with the processor via the board upon which the processor is mounted such that output from the temperature sensor may be received and processed at and by the processor and the board in turn may power the temperature sensor. Such an arrangement may be made by appropriate connection of temperature sensor pins with board's input/output (I/O). Alternatively, the temperature sensor may be arranged remotely and in remote communication with the processor. The temperature sensor may comprise a sensor array and may operate in the infrared. The temperature sensor may be configured to enable a scanning of the cooktop surface and generate as well as communicate a temperature landscape of the cooktop surface including indications of local temperatures within the surveyed landscape. The temperature sensor may further be configured to selectively focus in on any particular point within the scanned landscape and measure a local temperature for subsequent selective communication.

A similar arrangement may be applied to and for the ToF sensor. Output from the ToF sensor may be received and processed by the processor in the generation of the aforementioned image. The ToF sensor may be arranged above the cooktop surface such that a location for a utensil falls within a line of sight of the ToF sensor and the ToF sensor may then in turn generate an output based upon a detected reflection, the output being subsequently processed to determine whether the utensil is present and a level of any liquid accommodated within the present utensil. Regarding liquid level, such output may be obtained over time such that, for example, a rate of change of liquid within the utensil can be determined. Example application of the aforementioned include monitoring an increase in fluid levels due to boiling, the increase potentially leading to an undesired boil over and potentially flammable situation. Additionally, fluid level reduction as may occur from sauce reduction may also be monitored, the decrease potentially leading to an undesired evaporation/disappearance or destruction of the sauce and subsequently or otherwise to a potentially flammable situation. Other distances may also be determined, such as a distance between utensil or liquid and the fire prevention system. Likewise, by virtue of the aforementioned, the ToF may be used to determine a presence or absence of a utensil, namely, as may arise from when the reflection received off of the appliance itself as may be determined at least by the reflections' time of flight, becomes disturbed by the introduction and/or presence of the utensil within the ToF's field of view.

A similar arrangement may be applied to the DLP which may also be arranged in electrical communication with the processor such that an image generated by the processor may then be selectively displayed at a select location outside the fire prevention system 100. The select location may include the cooktop surface, utensil, foodstuff, nearby wall or surface and the like. The DLP may comprise a plurality of pins arranged in a matrix that line up with expansion headers of single board computers facilitating a plug-in arrangement.

The present fire prevention system may further include one or more communication modules arranged in local or remote communication with the processor and configured to download potentially useful information for the processor's considerations during determinations made as required by the present fire prevention system. Furthermore, the communication module may be configured to enable and facilitate communication between the processor and external elements, including querying information and information exchanges with data sources, the aforementioned inclusions in the present fire prevention system and the like. Still further communication may be made with appliances, such as smart appliances for the communication of cooking related information. The aforementioned information may include criteria for different thresholds which may be encountered during operation of the present fire prevention system, including particular temperatures and particular times of their detection which may be indicative of hazardous conditions. Additional information may include an impact of particular foodstuff and utensils on such determinations. Further information may include impacts of foodstuff preparation recipes and their impact on the thresholds. Still further information may include languages, images and other means of machine-machine and machine-human communication. Still further information may include particular protocols and procedures to be executed upon determination of particular thresholds have been exceeded, including particulars as to when, where and how such thresholds have been exceeded and relevant prevention measures and appropriate introductions thereof. The communication may be wired or wireless.

Other elements may be similarly included in the fire prevention system including appropriately arranged and configured alarm generator(s) configured and arranged as would be understood by the skilled person to enable and facilitate the herein described functionalities of the various embodiments. Likewise, other connection arrangements between and among the aforementioned may be made as envisioned by the skilled person.

The sensors and/or DLP may comprise individual standalone components mounted on individual circuit boards or may be arranged in combination on a single circuit board. Cooktop 102 is depicted as a typical household appliance though may comprise any suitable apparatus for generating heat applicable for cooking foodstuff which includes communication capabilities with the aforementioned processor. Heat generation may include radiance, induction, gas and the like as would be appreciated and applied by the skilled person. The utensils 106 are depicted as common variety pots and pans for illustrative purposes.

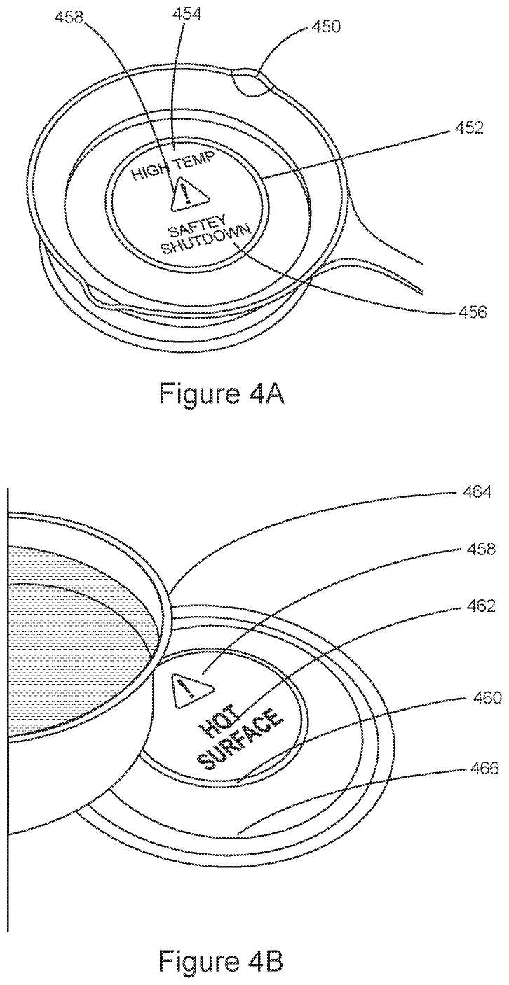

Returning to FIG. 1A, utensils 106 are positioned within a line of sight 108 of fire prevention system 100. Temperature sensor and projector assembly 114 is arranged to enable temperature sensing of all of the cooktop surface 104 by way of a scan as well as display a select image directly on the cooktop surface, on or in the utensil, and/or portions thereof. In particular, the select image displayed by the DLP comprises alphanumeric characters and colors within a utensil, as shown in FIG. 1B, for the convenience and ease of viewing and comprehending. Examples of image content are set out in FIGS. 4A and 4B. As further depicted in FIG. 1B, the fire prevention system 100 may further include a fixing element 114 for mounting the system, the fixing element comprising, for example, magnets and/or an adhesive layer.

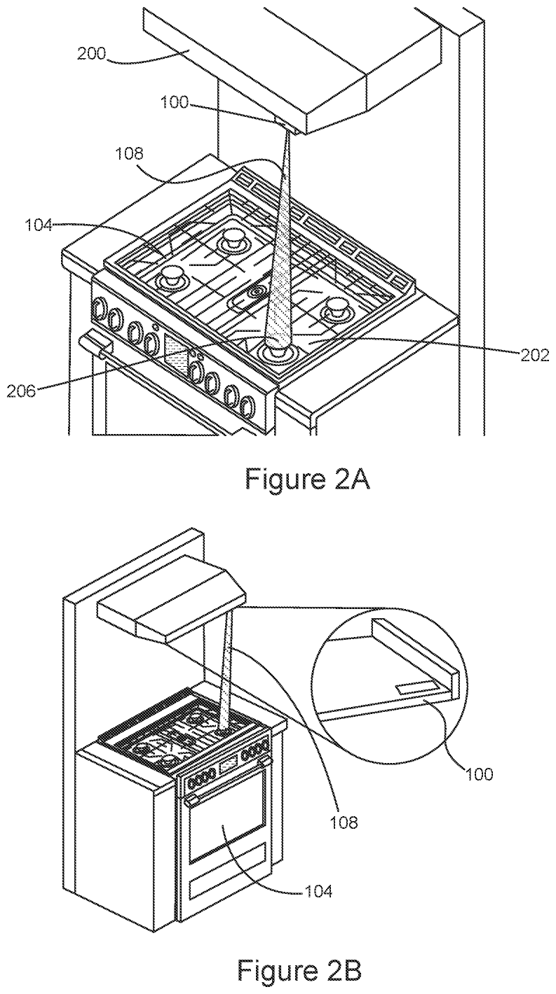

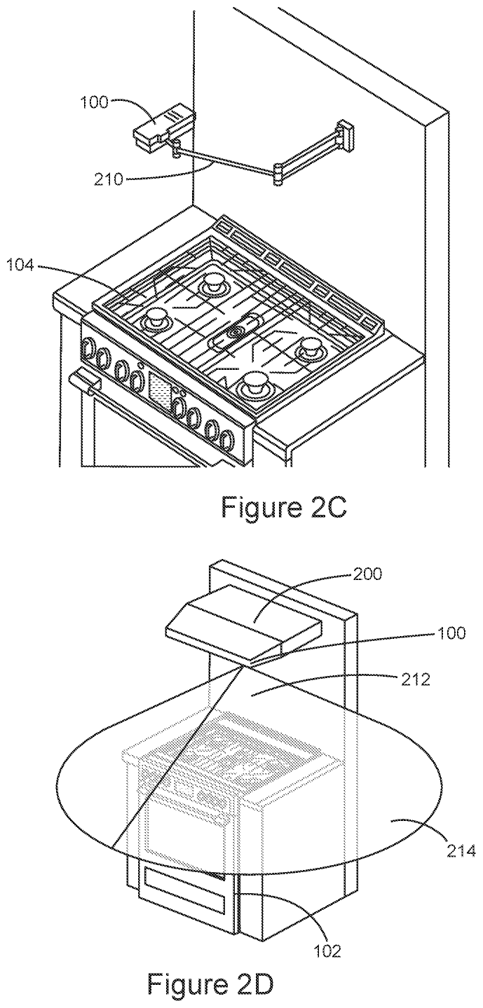

With respect to infrared (IR) sensors, depending upon application, the area to be measured (i.e., the target) should at least fill the instrument's field of view and ideally largely overlap. For example, as depicted in FIG. 1C, temperature sensor 120 has a field of view 122 on a proximate target 124 and distal target 126; the targets being intended for temperature measurement. Accordingly, first and second measurement spots 128 and 130 are created on the proximate and distal objects 124 and 126 respectively. The second spot 130 being about equal to the target size represents a good arrangement for assessing an overall temperature of target 126. In order to be sure to obtain temperature information from the entirety of the target, the measurement spots may be so expanded as to go outside the target, thereby guaranteeing that at least all of the target will be subject to temperature scan and measurement. The first measurement spot 128, being smaller than target 124, represents a good arrangement for selectively assessing a temperature in and at a more specific location, namely, a center and lightened portion of target 124. Depicting of wide and more narrow measurement spots as may be applied to an appliance is depicted in FIG. 2D wherein wide fields of view exceeding the bounds of the appliance are shown for appliance scanning applications while narrower fields of view selectively focusing on a particular location are shown for taking local temperatures. In addition to optical geometry as depicted in FIG. 1C, geometrical optics may be used to adjust (widen or focus) a measurement spot size and location as well as the field of view generally. Temperature sensors may also be pivotably mounted to physically adjust location of the field of view, measurement spot and the like as depicted in FIG. 1E.

FIG. 1D depicts a temperature sensor configured for a wider field of view, namely, covering most if not all of the surface of a cooktop and beyond. As depicted, sensor 132 includes a field of view 134 which may be considered as a grid 136 the size of which matches the intended field of view. As shown, sensor 132 is of the 4-pin type that includes a reference tab RT along with clock line SCL, ground GND, supply voltage VDD and serial data signal SDA, all configured and arranged to enable electrical connection and communication with the aforementioned processor via an/O. In operation, by virtue of the depicted field of view, sensor 132 may determine a scan for temperatures and distributions of same on the cooktop surface 138 with the same finding representation in grid 136.

With reference to FIG. 1E, the temperature sensor 140 may be selectively pivoted 142 in order to direct its field of view 144 and measurement spot 146 in particular on a desired location on the cooktop surface, such as heating element 148.

Operation of a temperature sensor in a kitchen environment is depicted in FIG. 1F. As shown, cooktop surface 150 emits thermal radiation 152 to be collected and measured by temperature sensor 160 in a smoky and/or humid environment 154. Facilitating thermal radiation collection, the sensor 160 includes optics 156 arranged to focus incident radiation and correct for any potential environmental obstructions onto photosensitive detectors 158 which then convert the incoming thermal radiation into electrical signals via amplification 162 and electronics 164. Other temperature sensor arrangements, including for example use of thermopiles, may be applied here by way of design choice. The electrical signals may then be converted into temperature values and further processed with respect to, for example, recipe steps, by the aforementioned processor or by other remote processing functionality. Accordingly, the instant temperature sensor operates in a contactless and remote manner so as not to obstruct or interfere with the cooktop environment nor potentially impact or damage foodstuff, utensils and the like operating or present in such environments.

In an embodiment and with general reference to FIG. 1G, the fire prevention system includes at least one time of flight (ToF) sensor configured for detecting a presence or absence of a utensil along with a level and change of level of liquid contained in a utensil which is located in the ToF sensors' field of view. As depicted, ToF sensor 180 includes transmitter 170 arranged to transmit a signal of known speed at and into utensil 184. The signal may comprise infrared light. The light is reflected by and from the utensil, the detection of which confirms the utensil's presence. The light may further reflect off of the surface of liquid present in the utensil. As depicted, starting with where no liquid is present in the utensil, light incidence 186 is reflected 188 off the internal bottom 190 of the utensil. A lowest liquid level 183 produces a first reflection 192 based upon a first incidence 191. Should the liquid rise, for example to a next higher level 181, as may be the case with boiling, a second reflection 194 is produced from a second incidence 193. Likewise, third and fourth reflections (196, 198) may be produced by third and fourth incidences (195, 197) at next higher levels (178, 176). Similarly, where liquid initially starts from a higher level and evaporates, as may be the case from reducing, the aforementioned would run in the inverse. Functionally, the ToF sensor may operate to statically determine a single liquid level in a single point in time; or non-statically determine a change in level height over a period of time. The distance to the liquid level at a particular time may be determined by analyzing the time difference between the time of emission, signal 171, and time of receipt of a particular reflection or return signal (173, 175, 177, 179, 188) to the sensor 180 after being reflected by the respective surface level of liquid (176, 178, 181, 183, 190). A number of different analysis may be applied for this calculation without departing from the spirit of the present embodiments. One such calculation entails multiplying the speed of the infrared light times the time of flight (to and from the liquid surface) and then divide the product by 2. Timer 174 may be employed to start during the exit of the infrared light and run until the respective return reflection is detected. The aforementioned processor may be appropriately configured and programmed to affect the aforementioned. Utensil presence or absence along with liquid level (and its rate of change) may be considerations in thresholds regarding hazardous conditions.

A functional depiction of a DLP is set out in FIG. 1H wherein, the digital light processing element 401 comprises a DLP Chip Board 400 on which processor 402, digital micromirror device (DMD) 404 and memory 416 are suitably mounted and configured. Incident radiation 409 from source 410 is color filtered 408 and focused, via for example a shape lens 406, onto DMD 404 from which an image 420 may be generated and projected 418 onto a screen 412. As applied to the embodiments set out herein, the projected image may comprise select images, alphanumeric text and/or color and/or the like which is then selectively projected onto a screen of the cooktop surface, utensil and/or foodstuff and the like.

As depicted in FIG. 2A, the fire prevention system 100 may be mounted on an underside of a vent hood 200 above and overlooking a cooktop surface 104. In this example arrangement, the sensor field of view 108 is adjusted so as to train on heating element 202 so as to create a measurement spot 206 on a particular part of the heating element 202.

FIG. 2B depicts a close up of the fire prevention system with a view from below. As shown, the fire prevention system is mounted below a right-hand front corner thereby affording the system a good field of view 108 of both the cooktop surface (not shown) and the heating element, the field of view comprising for example 10 degrees. The cooktop surface 104 depicted may comprise a radiant, gas or induction heat generation elements.

As depicted in FIG. 2C, the fire prevention system 100 may be mounted on a swing arm 210 so as to be selectively arranged above cooktop surface 104. Alternatively, the cooking assisting unit may be mounted under a floor of or elsewhere within or on a microwave oven (not shown).

FIG. 2D depicts a combination of field of views of the present fire prevention system 100 mounted on hood 200. A first field of view 212 is brought to focus on a forward right hand corner of the cooktop surface 104 while a second field of view 214 is brought to cover an entirety of the cook-top within the field of view of the fire prevention system. From within these fields of views, temperature surveys of varying target sizes may be made and processed so as to selectively pinpoint potential areas within the field of view whose temperatures rise above hazardous thresholds. Accordingly, center probing of particular heat sources may be affected, and the location of a potential hazardous situation may be determined, for example, which heating element or burner is creating which and what potential hazardous situation. With this information, appropriate prevention actions directed to the particular hazardous location, namely, directed towards the offending heating element or burner may be undertaken before a fire breaks out and/or related hazardous conditions arise. Such prevention actions range from: affecting the control of the heating element or burner, namely, safety shut-off; to introduction of fire suppression or other material in a more accurate and therefore effective manner; to where and what warning messages to depict; to where and what electronic messages to communicate to whom; and the like. A particularly effective implementation of the aforementioned may occur for when it is known in advance of such prevention measures what type of heat source or burner or fire situation/condition is at issue. For example, exposed flame heat sources may be treated accordingly and differently than induction sources; ignitable grease fires treated differently from flammable utensils; and the like. Further still, as will be detailed below, considerations may be made to not only a presence or absence of a utensil but its size, material of composition, contents and current or precise location—all factors of which may be consideration(s) when considering and introducing most effective prevention measures. Lastly, rates of temperature increases are also taken into consideration in order to, at least, time any preventive measures.

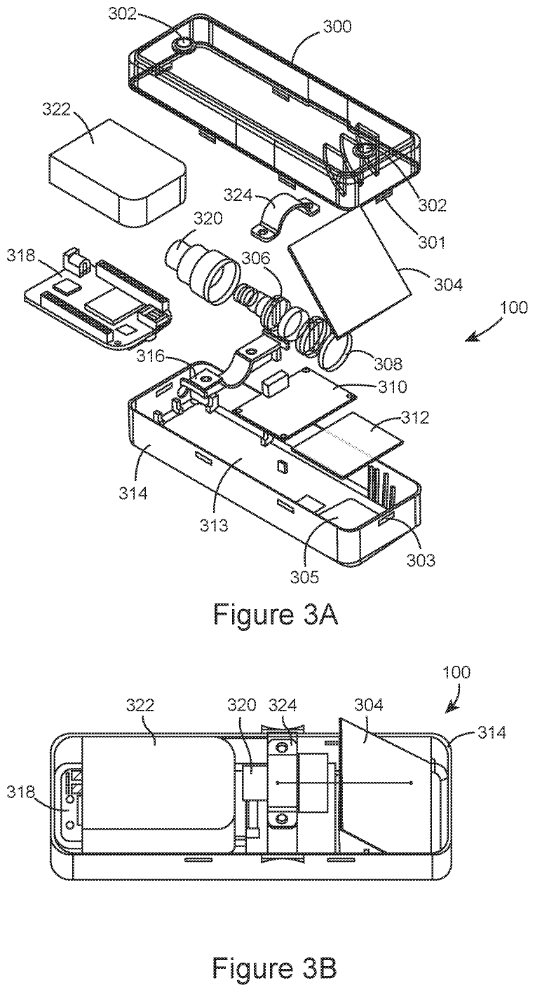

FIG. 3A depicts an exploded view and FIG. 3B depicted an assembled view of a fire prevention system 100 according to various embodiments of the present disclosure. With general reference to both figures, arrangement 100 includes a top housing 300 configured to mate with a base housing 314 by way of example clamps and clamp openings (301, 303) which may be arranged in a fixing relationship to mechanically fix the top housing 300 and base housing 314 together. Magnets 302 may be arranged on top of the top housing 300 for magnetically mounting the fire prevention system 100 as for example depicted in FIGS. 2A-2D, while other mounting elements may be used with or in place of the magnets.

The order of the elements accommodated within fire prevention system 100 are set out in an illustrative order. Board 318 may comprise the aforementioned single board computer arranged and configured to facilitate electrical communication with other elements housed within the fire prevention system 100 as well as with external devices by virtue of wireless communication. A sensor board 310 is further arranged to be in electrical communication with board 318 facilitating, together with board 310, accommodation and operation of the aforementioned sensors, including the temperature sensor and time of flight sensor (not shown). As such, the sensors may be individually mounted on separate boards or collectively arranged on a single board.

Returning to FIG. 3A, in the depicted fire prevention system 100, board 318 is arranged on a bottom 313 and within the confines of base housing 314, proximate to sensor board 310 and clear cover 312 which overlays opening 305 in the base housing. Optics holder 316 is arranged over sensor board 310, the optics holder 316 including accommodations for a lens holder 320 thereon. Within lens holder 320 are a number of optical elements including an optical lens and a lock ring locking the optical elements within the lens holder. Clamp 324 configured to overlay the lens holder 320 and mate with the optics holder 316 is arranged to hold the lens holder 320 in place while fixed to the optics holder 316. A mirror 304 is arranged proximate to the clear cover 312 at an angle, such as 45 degrees, such that radiation impinging thereon is reflected from the lens arrangement through the clear cover and out the opening 305 in the direction of the cooktop surface (not shown). A DLP, such as digital light processor display evaluation module 322 is arranged herein and configured to selectively project and display the image including real time cooking information below the fire prevention system with the processor, being in electrical communication with the DLP, generating the image and controlling the display location. The DLP may be of the compact, plug and play variety suitable for mobile projectors, appliances and the like. Its features may include an own chipset, such as the DLP200 (nHD), optical engine which may support up to 30 lumens, and an 8/16/24-bit RGB parallel video processor interface. The DLP may be board ready via an underside which includes pins arranged and configured to plug into an aforementioned single board computer and the like. The DLP may be further configured by the skilled person to generate free-form and on-demand displays. Other features may be included and/or substituted as would be understood by the skilled person. Forms and adhesive gaskets typically used for accommodating components in a housing are not shown for clarity purposes but would nonetheless be understood by the skilled person to be included and arranged within the fire prevention system 100.

In operation, the fire prevention system works to detect a hazardous situation before and/or as they occur, proactively generate alerts in response to such a detection and proactively initiate prevention measures directed to reversing the hazardous situation. An example of such hazardous situations may be when a temperature is detected to be equal to or greater than 285 degrees Celsius, indicative of eminent ignition of foodstuff and equal to or greater than 300 degrees Celsius, indicative of eminent ignition of various cooking oils. In other embodiments, the temperature may be less than 285 degrees Celsius. The processor may be further configured to eliminate false positives, such as a flaming during foodstuff preparation, wherein a momentary temperature spike in a controlled situation may be experienced. Such flaming, as may potentially occur from the intentional burning off of alcohol has the potential to generate momentary flashes of heat above the 285 degrees Celsius and 300 degrees Celsius. Accordingly, the processor may be programed to add a time element consideration to the temperature detection such that a two-part threshold is undertaken, namely, whether a temperature above any one of the aforementioned is detected for over a time threshold period of time. Likewise, rates of temperature changes may also be taken into consideration.

The fire prevention system according to embodiments of the present invention may be configured to generate an alarm when certain hazardous conditions are detected. The alarm may coincide with the detected hazardous condition. The alarm may comprise any combination of audio, visual and electronic format. Examples of visual alarms are depicted in FIGS. 4A and 4B. In FIG. 4A, the temperature of utensil 450 has been detected and determined to exceed an appropriate threshold for the safe operation of such utensil. Accordingly, an image 452 is displayed directly on the utensil warning the viewer that a hazardously high temperature 454 for the safe operation of the utensil has been detected and accordingly, safety shutdown 456, such as automatically reducing or eliminating the heat generation below the utensil 450 has been initiated. The color of such alarm may be red or other bright color so as to further grab the viewer's attention. The alarm may further include an urgency symbol such as an exclamation point in a brightly colored triangle 458. Such images may be useful in the event the viewer's language capacities are limited. In FIG. 4B, a utensil 464 is determined not to be present or entirely present on a heating element 466 while a hazardous temperature exceeding a threshold has been determined, thereby leading to a hot surface message 460 including appropriate alpha numeric text 462 and an image such as the aforementioned triangle encompassing exclamation point 458.

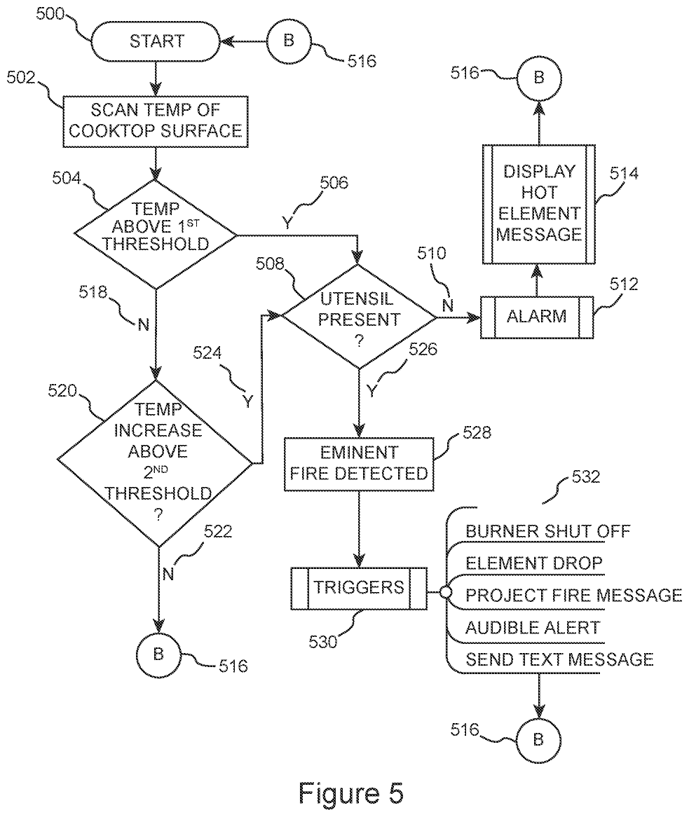

The present fire prevention system according to embodiments disclosed herein may operate according to a method as depicted in FIG. 5. The depicted method begins at step 500 and continues with a scanning of the temperature landscape of a cooktop surface 502. It is envisioned that a scan would be automatically performed every 300 seconds. A determination is then made whether any of the temperature detected is above any one of first thresholds 504. Any number of thresholds may be downloaded and/or otherwise made available for the processor to consider in light of its current application. Where the first threshold has been exceeded (506), a next determination is made whether a utensil is present (508). While this next determination step is directed to utensil presence or absence, other queries specific to particular thresholds may be undertaken in place of, prior to or subsequent to the utensil presence or absence. For example, a time duration of the threshold exceeding temperature may be determined before hand and a type of utensil may be determined subsequent to step 508. Accordingly, the single determination step of 508 has been depicted in FIG. 5 for illustration and brevity purposes. Returning to the method, where the utensil is determined not to be present (510), an alarm is generated (512) such as may be attributed to the presence of a hot heating element or burner (514). The method then returns to start 500 by virtue of connector 516. Returning to step 504, where the first threshold is found not to be exceeded, the temperature is compared with a second threshold (520) and if found not to exceed (522) the method then returns to start by virtue of connector 516. If the second threshold is found to be exceeded, step 508 is repeated (as depicted—presence of a utensil) with the aforementioned steps following thereto in the event the utensil absence is determined. If the utensil presence is determined, the method continues, as would be with either first or second thresholds having been exceeded, with a determination that an eminent fire has been detected (528) to be followed by the triggering (530) of certain prevention measures (532), including burner (safety) shut off, element drop, fire message projection, audible alert and text message sending. The method then returns to start 500 by virtue of connector 516.

The communication functionality of the present embodiments may comprise network and communication chips, namely, semiconductor integrated circuits that use a variety of technologies and support different types of serial and wireless technologies as envisioned by the skilled person. The processor functionality of the present embodiments may be disposed in communication with one or more memory devices, such as a RAM or a ROM, via a storage interface. The storage interface may connect to memory devices including, without limitation, memory drives, removable disc drives, etc., employing connection protocols such as serial advanced technology attachment, integrated drive electronics, IEEE-1394, universal serial bus, fiber channel, small computer systems interface, etc. The memory drives may further include a drum, magnetic disc drive, magneto-optical drive, optical drive, redundant array of independent discs, solid-state memory devices, solid-state drives, etc. The memory devices may store a collection of program or database components, including, without limitation, an operating system, a user interface application, a user/application data (e.g., any data variables or data records discussed in this disclosure), etc.

It will be appreciated that, for clarity purposes, the above description has described embodiments of the technology described herein with reference to different functional units and processors. However, it will be apparent that any suitable distribution of functionality between different functional units may be used without detracting from the technology described herein. Hence, references to specific functional units are only to be seen as references to suitable means for providing the described functionality, rather than indicative of a strict logical or physical structure or organization.

The specification has described systems and methods for improving use of cooktops arising from attention to safety and foodstuff preparation by way of display and communication of real time cooking information. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

It is intended that the disclosure and examples be considered as exemplary only, with a true scope of disclosed embodiments being indicated by the following claims.

1. A fire prevention system for an appliance configured to prepare foodstuff, the system comprising:
a contactless temperature sensor arranged with the appliance within the temperature sensor's field of view, the temperature sensor configured to generate a first output comprising a temperature survey of the appliance;
a time of flight sensor arranged with the appliance within the time of flight sensor's field of view, the time of flight sensor configured to detect a presence and absence of a utensil and generate a second output comprising an indication of the presence or the absence; and
a processor arranged in communication with the temperature sensor and time of flight sensor, the processor configured to: receive the first output and the second output; and initiate fire prevention measures when the first output comprises a temperature equal to or greater than 285 degrees Celsius and the second output comprises the presence of the utensil.

2. The fire prevention system according to claim 1, wherein the processor is further configured to initiate hot surface warnings when the first output comprises a temperature equal to or greater than 285 degrees Celsius and the second output comprises the absence of the utensil.

3. The fire prevention system according to claim 2, wherein the processor is further configured to:
determine a rate of temperature change of the appliance;
compare the rate with a first threshold;
generate the fire prevention measures when the rate of change exceeds the first threshold, the first output comprises a temperature equal to or greater than 285 degrees and the second output comprises an indication of the presence of the utensil; and
generate hot surface warnings when the rate of change exceeds the first threshold, the first output comprises a temperature equal to or greater than 285 degrees and the second output comprises an indication of the absence of the utensil.

4. The fire prevention system according to claim 3, further comprising:
a communication module in communication with the processor, the communication module configured to communicate wired or wirelessly, upon instruction from the processor; and
wherein the prevention measures comprise communication of the instructions to the appliance.

5. The fire prevention system according to claim 4, wherein:
the processor is further configured to generate text messages and communicate the text messages by the communication module; and
the prevention measures and hot surface warnings further comprise communication of text messages comprising at least one of alphanumeric characters and images.

6. The fire prevention system according to claim 5, further comprising:
a digital light processor in communication with the processor and arranged to depict an image on at least one of the appliance, the utensil and foodstuff arranged within the utensil or on the appliance, upon instruction from the processor;
wherein the prevention measures and hot surface warnings further comprise the visual alarm comprising at least one of alphanumeric characters, colors and images.

7. The fire prevention system according to claim 6, further comprising:
an audio alarm generator in communication with the processor and configured to generate an audio alarm, upon instruction from the processor; and
wherein the prevention measures and hot surface warnings further comprise an audible alarm.

8. The fire prevention system according to claim 1, wherein the temperature sensor comprises at least one of an infrared sensor and a sensor array.

9. The fire prevention system according to claim 1, further comprising mounting elements configured to mount the fire prevention system within a microwave oven or above the appliance within at least one of a vent hood and a swing arm.

10. A method for fire prevention at an appliance, comprising the steps of:
surveying a temperature of the appliance with a contactless temperature sensor;
determining a presence or absence of a utensil on the appliance with a time of flight sensor;
initiating fire prevention measures when the temperature is equal to or above 285 degrees Celsius and the presence of the utensil is determined; and
initiating hot surface warnings when the temperature is equal to or above 285 degrees Celsius and the absence of the utensil is determined.

11. The method according to claim 10, wherein the fire prevention measures comprise at least one of: an appliance safety switch-off instruction; a text message; a visual display;
and an audio alarm.

12. The method according to claim 10, wherein the hot surface warnings measures comprise at least one of a text message, a visual display, and an audio alarm.

13. The method according to claim 10, wherein fire prevention measures and hot surface warnings are configured to be wired or wirelessly transmitted.

14. The method according to claim 10, wherein the temperature sensor is at least one of an infrared sensor and a sensor array.
